(19) United States
(12) Patent Application Publication
(10) Pub. No.: US 2011/0263339 A1
(43) Pub. Date: Oct. 27, 2011

(54) Ergonomically-designed dual station, dual display gaming station with player conveniences

(76) Inventors: Joseph W. Cole, Las Vegas, NV (US); Ernest G. Cole, Las Vegas, NV (US)

(21) Appl. No.: 13/135,181

(22) Filed: Jun. 27, 2011

Related U.S. Application Data
(63) Continuation of application No. 09/750,742, filed on Dec. 28, 2000, now abandoned.

(51) Int. Cl. A63F 13/08

(52) U.S. Cl. 463/46

(57) ABSTRACT

A game station is configured to present multiple games to each of two players. The game station includes a base unit having first and second playing surfaces extending outwardly for supporting game cards used to play a game. A console extends upwardly between the playing surfaces and supports first and second side-by-side electronic video displays on each side facing the player surfaces. Independent game controllers are provided for each of the displays for presenting individual games at each of the displays. The game station includes wager accepting devices for playing the games presented on the video displays. The game station includes player conveniences such as seat, coat hook, and transparent game card cover extending over the playing surfaces. The game station as configured permits players located at each side of the station to engage in the play of at least three independent games concurrently.

### RELATED APPLICATION DATA

This application is a continuation of U.S. patent application Ser. No. 09/750,742, filed Dec. 28, 2000.

### FIELD OF THE INVENTION

The present invention relates to devices for presenting games, and more particularly those games comprising wagering games which are regulated or licensed.

### BACKGROUND OF THE INVENTION

A wide variety of devices are known for presenting wager type games. These devices include video and slot machines. These devices normally include a single display which presents the game to the player. For example, a video poker machine typically includes a video display on which information, including dealt cards, is displayed to the player. Thus, one limitation of these types of machines is that in general they are arranged to present only a single game. If a player desires to play a different game, the player must locate another machine which presents a different game.

In some instances, a single display is utilized to display one of several games. For example, a game may include a menu of games which a player may select from. After making a selection, the selected game is presented on the video display. While these machines offer a player the opportunity to play different games, they still suffer from a number of drawbacks.

One disadvantage of current game configurations relates to the layout of the game machine. Most commonly, these machines have an upright cabinet which houses the necessary game circuitry, including the video display. These cabinets are generally tall and narrow, allowing a casino to place a large number of the cabinets in a given floor area. This allows a casino to increase the number of profit-producing machines in a casino area. However, this configuration is undesirable to players.

A first problem with this configuration is that players must normally sit on a bar-stool or other raised type of chair to be at play level, i.e. at the same height as the display and game machine inputs. This seating arrangement is generally uncomfortable and precarious. Shorter people often times have trouble getting into and out of these types of raised seats.

Another problem with this configuration is that the cabinets are very tall, and extend far above the head of the player. The game machine thus blocks the view of the player to other areas of a casino. In some instances, where rows of the machines are closely spaced, a tunnel effect is created. This effect is not pleasurable and may result in the player feeling confined.

These types of game machine are also not generally accessible by physically disabled players. For example, a player who is wheelchair bound can not move into one of the raised seats. Further, the display and controls are difficult to access because they are positioned high above the floor. If the player remains seated in their wheelchair, they may find it difficult to access the controls and view the display.

Another problem with these game machines is that they have a base which extends vertically to the display and controls, preventing a player from sitting close to the display and controls. When seated, a player's knees abut the vertical game, such that the player's torso is positioned several feet away from the game itself A player must continuously bend over or reach outwardly to play the game, which is tiring and uncomfortable.

A number of other game configurations other than that described also exist. These other configurations have one or more of the same or similar drawbacks. For example, “in bar” games exist in which a display is mounted in a table or counter, with the display facing upwardly. Generally, clear glass or other material extends over the display, the glass or other material forming a support surface for drinks or the like. This game arrangement has the disadvantage that the player must normally sit on a bar stool to play the game, the game is difficult to see unless the player is positioned over the display, and the no personal space is defined by the game, with all players around the game being able to see the game.

Another variety of game is similar to the upright type game, but includes a control panel which extends outwardly from the display towards the player. The control panel generally supports buttons and other input devices, and is thus not well suited to supporting drinks, food or the like. Again, the game does not permit a player to sit close to the game controls and display, as such are generally located in the same plane as the base portion of the game which the player's knees abut.

As stated above, game machine income is generally associated directly with the number of game machines located in a given space. As such, game operators generally place the game machines side-by-side in rows. As stated above, the game machines are configured to be relatively narrow to occupy little space. When positioned side-by-side, little space thus exists between players playing adjacent game machines. When a plurality of players are all seated playing adjacent games, this arrangement makes it difficult to ingress and egress to a particular machine (such as between adjacent chairs associated with adjacent machines). In addition, players often feel uncomfortable having a person sit so close to them. Gamblers especially have this feeling as they often feel that their betting and play strategy is personal and do not want someone else to view their actions. In some instances, this results in players only playing every other game machine, with intervening game machines providing buffers. Of course, this frustrates the gaming operator because the effective number of game machines played in a given area is then only half of the actual density of the machines.

More commonly, players wish to gamble longer periods of time. Traditional gaming machines are not accommodating to the player's desire. A player who wishes to gamble a long period of time is likely to want food and drink. The gaming machines do not accommodate such. A player is often forced to set their food or drink on the floor or other surrounding locations. This is undesirable, as the food or drink may be spilled and is accessible by others.

Players also often wish to engage in other activities while playing a gaming machine. For example, a player may wish to take a short break to read materials in preparation of placing a bet with a sports book. The traditional gaming machines do no accommodate these activities by a player.

It is an object of the invention to provide a gaming machine configuration which overcomes one or more of the above-described problems.

### SUMMARY OF THE INVENTION

A game station for presenting one or more games for play by a player is disclosed.

In general, the game station is arranged to address player comfort and personal space, and allow a player to engage in a wide variety of activities, including the playing of more than one game at the same time. The game station is arranged to be played by a player in a normal seated position (i.e. regular chair/wheelchair height). The game station is configured to simultaneously present a plurality of games to a player via one or more independent displays. The game station is also arranged to permit a player to simultaneously or concurrently play one or more games in addition to those presented with the one or more independent displays.

In one embodiment, the game station includes a base unit. The base unit has a supporting base portion and at least one generally planar playing surface positioned above the base portion and extending outwardly of at least a portion of the supporting base for accepting the legs of a player thereunder. The base unit also includes a console extending upwardly from the generally planar playing surface. A first display and a second display are associated with the console and are adapted to display information to a player. The supporting base portion defines an interior space housing at least one game controller for presenting a game to the player on at least one of the first and second displays. In one embodiment, the game station defines two distinct and opposing player areas, each having independent playing surfaces and displays.

In one embodiment, the game station is arranged to present at least two independent games, preferably at least one Class II game and at least one Class III game. These games may be presented simultaneously on the same display, or on different displays. In addition, the game station permits a player to play one or more games on the playing surface. In one such embodiment, independent first and second gaming controllers are provided for implementing the games presented by the one or more displays.

In one embodiment, information in addition to game information may be displayed on one or both of the displays. This information may comprise a movie, the Internet, a video feed from another location such as a child care facility, or television. In such an embodiment, the displays may be of the “picture-in-picture” type.

In one or more embodiments, the game station may include but a single display or more than two displays. In one embodiment, the game station includes a single display adapted to simultaneously or concurrently display information regarding at least two games. In a preferred embodiment, a signal processor or other means are used to divide or split the display area of the display into regions where information regarding different games are displayed. For example, the display may be split into a left and right side, with information regarding different games presented on each side. In another arrangement, a main or first game may be presented in the center of the display and one or more other games or other information presented in smaller “windows” located in the corners. In another embodiment, three or more displays may be used in a like manner to present games simultaneously or concurrently, along with, if desired, other content such as a television feed.

In a preferred embodiment of the invention, the games which are presented are of the type which require the player to place a wager to play, and when the player achieves a winning outcome result in an award to the player. In such an embodiment, at least one of a variety of devices are provided which permit a player to associate credits or value with the game station, which credits can be used as wagers for playing one or more of the independent games.

In accordance with the invention there is provided a game station which is capable of presenting at least two independent games to a single player at the same time. This permits a player to play more than one game at the same time, raising the interest of the player and the potential revenue to the gaming operator. In a preferred embodiment, the games are of the Class II and Class III type, and result in a symbiotic relationship between the games resulting in the player playing both games at the same time with little interruption between the two.

In accordance with the invention there is provided a game station which is ergonomically friendly to a player, increasing the player's desire to play games at the game station for a longer period of time. This effect reduces game station down time, thus increasing the profits to the game operator. The game station has a generally planar playing surface which the player can use to both play games and use as a support surface for playing games displayed on the displays. The playing surface is arranged in cooperation with a seat such that the player's legs are conveniently located under the playing surface, both allowing the player to sit closer to the game area and to sit level with the game area.

The arrangement of the game station to accommodate a seated player allows wheelchair-bound and other physically disabled players to access the game station. A wheelchair can be placed so that the player's legs extend under the play surface, with the displays and controls conveniently located for the player.

The game station is arranged with a wider, rather than taller configuration, providing to the player of the station substantial personal space and making the player feel more comfortable. Even when placed adjacent to one another, the game station provides adequate personal space to the player of each station.

In one embodiment the game station defines two play areas back-to-back. In this embodiment, an upwardly extending console generally screens the players on either side thereof from one another. At the same time, however, the game station does not obstruct the player's view of objects and events further in the distance. For example, a player participating in a bingo or keno game can see over the top of the game station to view a display screen, a caller or other devices and events. This configuration both furthers the ability of the player to participate in other activities, but also contributes to the player's comfort while playing a game or games at the game station.

The configuration of the game station allows for the presentation of numerous games within a minimal amount of space. Such an arrangement allows a gaming operator to maximize the number of games per unit space, thus maximizing the amount of revenue generated per unit space. Such an arrangement is permitted by having the plurality of games presented, by spreading the associated game implementation and presentation devices about the game station, and by the back-to-back play area configuration. Game controllers and similar devices are located within a narrow, generally vertically extending base area below the play surfaces. Associated game implementing devices are conveniently located next to the console housing the displays. The game implementing devices, in one or more embodiments, include a currency acceptor (such as a bill validator) and receipt printer.

In one or more embodiments, the game station is provided with a wide range of other player convenience and comfort features leading to a player's extended play time. In one embodiment, the game station includes a seat having a tray. The tray conveniently provides a location for a player's personal items, for food or beverage, and for performing functions such as writing. In one embodiment, a hook is provided for supporting a player's personal items, such as a purse, close to the player and off of the floor. In one embodiment, the game station includes a cup holder for supporting beverages. A foot rest is associated with the seat for supporting a players feet and legs, preventing them from tiring.

The player may also utilize the play surface for the storage of personal items and food and beverage. The player may also utilize this space for reading and writing, in addition to playing games such as bingo or keno.

In one embodiment, the game station includes a data input device, such as a jack, through which game station control data may be provided, such as from a computer or other enabling control device used by a physically disabled or impaired player. In one embodiment, the game station includes a player tracking feature for specially configuring the game station to meet the player's needs.

One aspect of the invention is a method of presenting a plurality of independent games in which credit is provided by a player through a common credit acceptance device and the player is permitted to allocate the provided credit to one or more of the variety of games which are presented by or which may be played at the game station. In one embodiment, a game station is provided having two displays for presenting independent games and which includes a common bill validator, coin acceptor, coupon reader or other credit input/confirmation device. The game station is configured to permit the player to allocate the provided credits to one or more of the games presented or playable at the game station.

In one embodiment, instead of comprising a unitary structure, the game station actually comprises two or more separate units which are associated with one another for presenting two games to a single player. In one embodiment, the individual units are placed side-by-side or in other proximity for permitting a player to play games presented by both the units. In a preferred embodiment, a common credit acceptance/input device is associated with all of these units for permitting a player to provide credit for playing the presented games.

Further objects, features, and advantages of the present invention over the prior art will become apparent from the detailed description of the drawings which follows, when considered with the attached figures.

### DESCRIPTION OF THE DRAWINGS

FIG. 1 is a perspective view of one embodiment game station of the present invention;

FIG. 2 is a schematic illustrating a game control of the game station illustrated in FIG. 1;

FIG. 3 is a front view of a game station of FIG. 1 illustrated in the direction indicated therein;

FIG. 4 is a front view of a game station in accordance with an alternate embodiment of the invention;

FIG. 5 is a plan view of a game station in accordance with another embodiment of the invention; and

FIG. 6 is schematic view of a menu displayed by a display of a game station of the invention.

### DETAILED DESCRIPTION OF THE INVENTION

The invention is a game station for simultaneously or concurrently presenting one or more independent games for play. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the present invention comprising a game station at which one or more independent games may be simultaneously or concurrently presented for play to one or more players. The game station includes means for presenting a game, input means for permitting a player to play the game, and in one or more embodiments, means for accepting a wager.

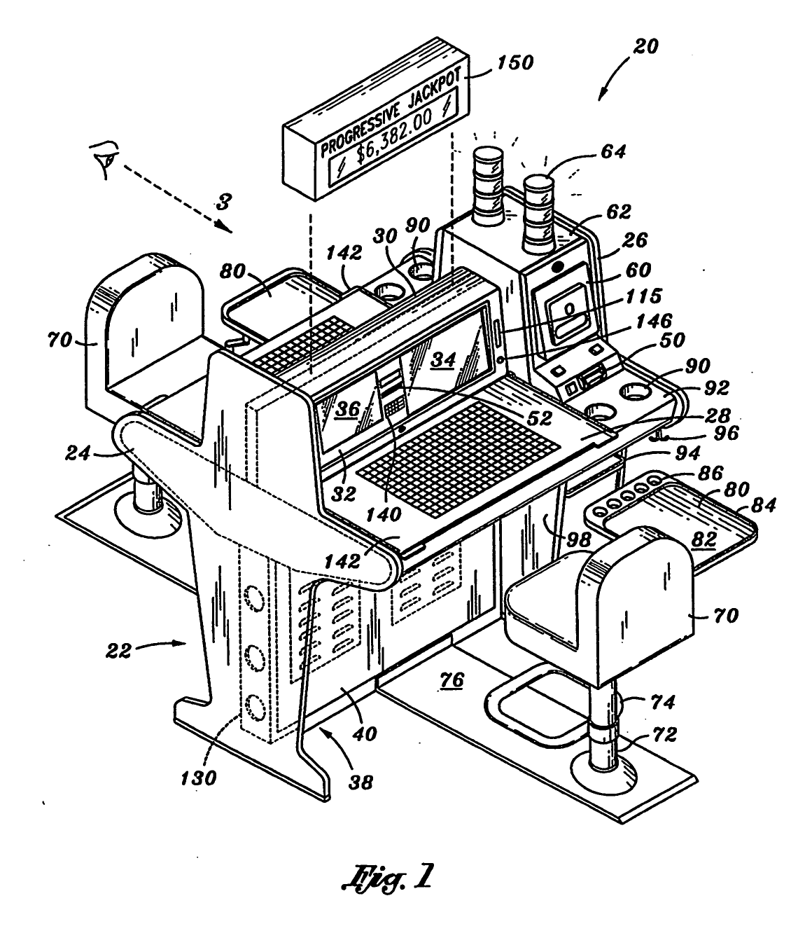

One embodiment of a game station 20 in accordance with the present invention will be described with reference to FIG. 1. The game station 20 includes a base unit 22. In general, the base unit 22 comprises a support structure for other elements of the game station 20, and provides a number of surfaces for use by a player.

As illustrated, the base unit 22 comprises a first end support 24 and a second end support 26. In general, each of these supports 24,26 comprises a panel member serving to provide support and enclosure functions.

In a preferred embodiment, the game station 20 is adapted to provide two player areas (i.e. a first and second play area) such that two players (or groups of players) may utilize the single game station 20 at the same time. In this embodiment, the two player areas are located at opposing sides of the game station 20. In general, the following description is of the features of the game station 20 as they pertain to one of the player areas. It will be understood that the other player area may be or is similarly arranged.

A play surface 28 is defined between the first and second end supports 24,26. Preferably, the play surface 28 is a substantially horizontal surface for use by a player. The play surface 28 may have a variety of dimensions. In a preferred embodiment, the play surface 28 is sufficiently large to accept at least three standard paper bingo cards side-by-side, and at least two rows of said cards in depth. In this embodiment, the play surface 28 is about 28 inches wide and about 14 inches deep.

As illustrated, the first and second end supports 24,26 include “arm” portions which extend outwardly generally horizontally from a main upright section. Corresponding arm portions of the first and second end supports 24,26 aid in supporting the player surface 28. In general, the play surfaces 28 are positioned above an upwardly extending base portion 38 (described below) of the base unit 22.

In the preferred embodiment illustrated, the game station 20 includes two play surfaces 28, one play surface 28 corresponding to each of the two player areas. In one embodiment, a console 30 separates the two play surfaces 28. The console 30 extends upwardly above the play surfaces 28 of the play areas of the game station 20. As illustrated, the console 30 extends from the first end support 24 towards, but not completely to, the second end support 26.

Also referring to FIG. 3, the console 30 includes a face 32 which is oriented towards the play surface 28. In one embodiment, the face 32 extends upwardly at an angle of approximately 20 degrees from horizontal (i.e. nearly, but not quite vertical). A first display 34 and a second display 36 are associated with the console 30. In one embodiment, the face 32 of the console 30 has a pair of openings through which the displays 34,36 project.

In one or more embodiments, each display 34,36 comprises a generally thin or flat display, such as an LCD type display. In such event, the displays 34,36 are preferably mounted to the face 32 of the console 30. The displays 34,36 may be of a variety of other types, such as CRT, plasma or the like. As described below, the use of generally thin or flat displays contributes to the game station 20 having a generally narrow profile, resulting in a number of advantages.

As described in more detail below, each display 34,36 is capable of displaying information to a player. In a preferred embodiment, the displays 34,36 are arranged to display information regarding two independent, and most often different, games.

Below the play surface 28 is a base portion 38 of the game station 20. An enclosed interior area is defined by the first end support 24, second end support 26, and opposing cover panels 40. Preferably, the base portion 38 of the game station 20 has a relatively small “thickness” dimension, i.e. small dimension between two player areas. In this manner, as described in more detail below, the play surface 28 of the game station 20 conveniently extends outwardly towards a player using the station, and yet the recessed base portion 38 accommodates the players legs extending under the play surface 28. Preferably, to accommodate the player's legs without them abutting the base portion 38, the play surface 28 extends outwardly from the base portion by at least about 12 inches.

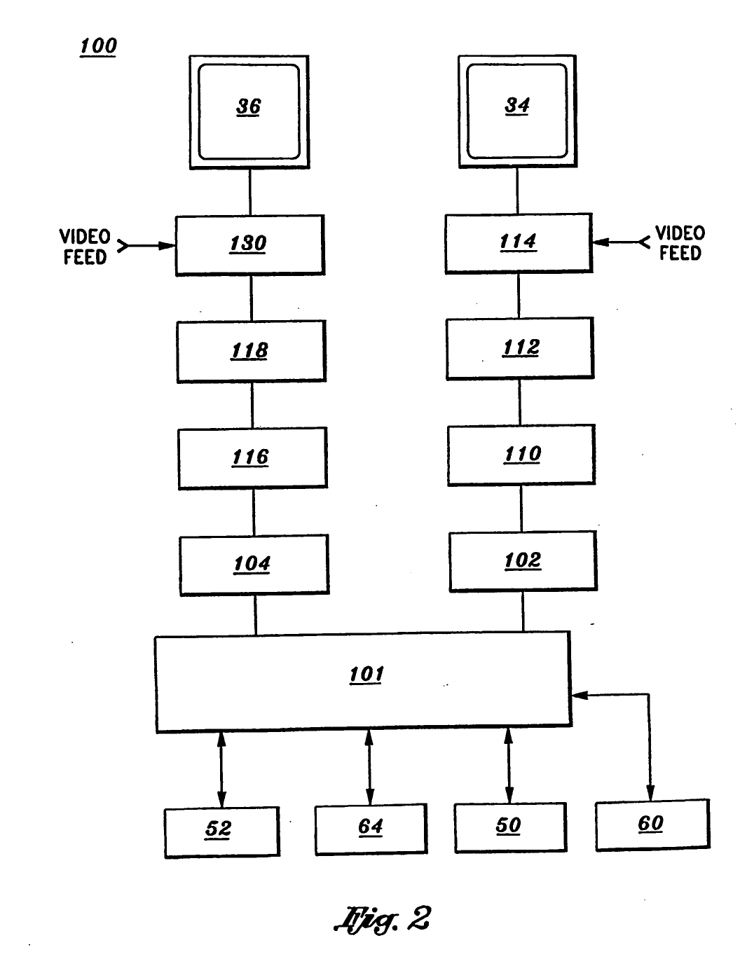

In one embodiment, the interior defined by the base portion 38 houses at least one game controller (described in more detail below and illustrated in FIG. 2) for use in presenting the games for play to a player. As is well known, a number of peripheral devices are associated with the game controller. As described above, at least one peripheral comprises one or both of the first and second displays 34,36.

In the preferred embodiment of the invention, one or more of the games presented for play are of the type which requires a player to place a wager to participate, and if the result of the game presented is one of one or more predetermined winning outcomes, results in an award to the player. Thus, in one or more embodiments, and as illustrated in FIGS. 1 and 3, the game station 20 includes means for accepting a wager. In one embodiment, the means includes or comprises a bill validator 50. The bill validator 50 is adapted to accept paper currency (such as U.S. currency) and/or coupons. The bill validator 50 includes a slot through which the paper currency may be passed. As is well known, the bill validator 50 is arranged to determine (such as by optical comparison) if a presented paper bill is authentic. If not, then the currency is rejected. If so, then the bill or currency is preferably routed to a currency stacker (not shown) or other currency storage device.

If the currency is accepted, then the value of the currency is preferably indicated to the game controller. The value of the provided currency is indicated as credit or value which the player may utilize for playing a game.

In one embodiment, a card reader 52 is provided for reading a player card. Such a card may include information facilitating a player providing the necessary credit(s) for playing the game. The card may include a magnetic stripe, bar-code or other element which represents value, such as a number of credits and their value. Alternatively, the element(s) may comprise a code which is utilized to access information regarding value belonging to the player. For example, the game station 20 or a remote database may include information regarding credits belonging to a player which may be accessed and played by a player, the player credit information identifiable by the code associated with the card.

In one or more embodiments, the game station 20 may include a coin acceptor (not shown) for accepting coins provided by a player. Such a coin acceptor may include a comparitor for determining the authenticity and value of the presented coin, and a coin hopper or other device for storing accepted coins. This coin hopper may also be used for dispensing coins.

Means are preferably provided allowing a player to place a bet from the credits provided by the player. This means may comprise one or more buttons or, in an embodiment where the displays 34,36 comprise touch-screen devices, areas of the displays 34,36.

During play of the game, a variety of player input may be required or permitted. In one embodiment, the input may be provided by buttons or similar electro-mechanical devices. Alternatively, or in addition, the input may be provided through the displays 34,36.

In the event a player is determined to be the winner of a particular game or games, then the player may be awarded winnings. In one embodiment, the winnings are paid in the form of credits. The credits may be used by the player to play additional games on the game station 20, or may be “cashed in” by the player. For example, the player may obtain payment in the form of coins and/or currency by the game operator for those credits belonging to the player:

In one embodiment, credits won by a player may be stored on the player's tracking card. Alternatively, the credit information may be stored at the game station 20 or at a remote location, such as a remote database.

Although not shown, in one or more embodiments, winnings may be paid in the form of coins. These coins may be paid from a coin hopper to a coin tray accessible by the player. Coins may be provided to the coin hopper via a coin accepting device by which a player provides coins for credits to play the game. Such an arrangement is well known in the art.

In one or more embodiments, a printer 60 is provided for printing receipts. The printer 60 may be of a variety of types, such as thermal, or laser or ink deposition. Preferably, the printer 60 is adapted to print information on a paper or other ticket element. In one embodiment, the printer 60 is arranged to be controlled by the gaming controller and print credit or other information. Such a receipt may be coded or include human-readable information. The receipt may be used by a player to obtain, in exchange, currency and/or coins. The receipt may also provide game play information, such as a unique identification number for a stored game in a system which permits a player to cease play of a game and continue the play of the game at a later time.

In one embodiment, the bill validator 50 and receipt printer 60 are mounted in a housing 62. As illustrated, the housing 62 is positioned between the console 30 and the second end support 26 of the game station 20. The housing 62 may be of a variety of sizes and shapes. In one embodiment, the housing 62 is shaped similar to the console 30, having sloped faces and a generally planar top. In order to accommodate the bill validator 50 and receipt printer 60, the housing 62 is slightly taller than the console 30.

Still referring to FIGS. 1 and 3, a light tree 64 extends upwardly from the top of the housing 62, i.e. the highest portion of the game station 30. The light tree 64 preferably includes one or more lights of different colors or is otherwise capable of generating visually distinguishable signals to a viewer. As is well known in the art of gaming machines, the light tree 64 is preferably controlled by the game controller and provides one or more visual signals associated with one or more events. For example, in the event of a large winning event or a malfunction, one or more of the lights of the light tree 64 may be illuminated.

Preferably, the game station 20 includes a plurality of player comfort and convenience features which, while not necessarily utilized to implement or play a presented game, make it more desirable for a player to play a game at the game station 20. Referring to FIG. 1, a seat 70 is associated with the game station 20. The seat 70 may be of a variety of types and styles. As illustrated, the seat 70 is mounted on a post 72, whereby the space below the seat 70 remains generally open.

In a preferred embodiment, the seat 70 is connected to the game station 20. In this manner, the seat 70 can not be removed from the game station 20, rendering the game station undesirable to use (as such might then require the player to stand to use the game station). As illustrated, a support 76 extends from the panel 40 of the game station 20. The support 76 is generally planar and mounted near the bottom of the panel 40, such that the support 76 is generally supported by a floor or other surface on which the game station 20 is positioned. The post 72 is preferably connected to the support 76.

The seat 70 may be provided with a plurality of features. In one or more embodiments, the seat 70 may be provided with a back-tilt feature, the seat may be raised and lowered, and the seat may be moved towards and away from the game station 20. In one embodiment, these seat movements may be accomplished by the player—i.e. human power. In another embodiment, one or more of the movements may be accomplished with one or more motors or similar devices—i.e. automated. In one or more embodiments, the seat 70 may be provided with an adjustable lumbar support. In one embodiment, one or more heating elements are provided for heating the seat.

The heating elements may be controlled with a thermostat or other control accessible by a player. In another embodiment, the seat may include a massaging device, such as moving rollers or the like. In one or more embodiments, one or more arm rests may be associated with the seat 70.

In one embodiment, a foot rest 74 is associated with the seat 70. As illustrated, a foot rest 74 extends outwardly from the post 72. The foot rest 74 may have a variety of configurations. As illustrated, the foot rest 74 is constructed from generally circular tubing forming into a generally square geometry. In an alternate embodiment of the invention, a foot rest may be connected directly to the game station 20. For example, in one embodiment, a bar or similar member may be supported by the first end support 24 and/or second end support 26. In one embodiment, the position of the footrest 74 may be adjusted (such as raised or lowered).

In one embodiment, a tray 80 is conveniently provided near the seat 70. In the embodiment illustrated, the tray 80 is supported by the post 72. The tray 80 may have a variety of configurations. In one embodiment, the tray 80 has a generally planar main area 82. Preferably, this main area 82 is recessed below an edge 84 for maintaining items on the tray 80. In one embodiment, a plurality of bores or passages 86 are provided through a front portion of the tray 80. These passages 86 may accept therein a plurality of items, such as drinks, food, personal items and the like.

In one or more embodiments, the tray 80 is movably mounted so that a player may change the position of the tray. For example, the tray 80 may be hingedly mounted, thereby permitting it to be raised into a generally horizontal use position, or lowered into a generally vertical position in which it extends along the seat 70.

In one embodiment, and as illustrated in FIGS. 1 and 3, the game station 20 includes a plurality of cup holders 90. As illustrated, the cup holders 90 comprise recessed areas in a counter section 92 of the game station 20 or passages entirely therethrough. The counter section 92 preferably comprises a generally planar area of the game station 20 between the play surface 28 and the second end support 26 of the game station 20, and in front of the housing 62. The cup holders 90 may have a variety of shapes, sizes and configurations. In general, however, the cup holders 90 are preferably designed to accept a cup or other container and support the cup or container in a generally upright position to maintain the material therein. Of course, the cup holders 90 may have a variety of forms, and may comprise separate elements which extend from the base unit 22.

In one or more embodiments, a garment/support hook 96 is associated with the game station 20. In one embodiment, the garment hook 96 extends downwardly below the counter section 92. The hook 96 has one or more upwardly extending members for accepting an item, such as a portion of a garment, a purse strap or other item, and supporting that item.

Referring again to FIG. 1, a trash bin 94 is provided for disposing of items. In one embodiment, a divider 98 is provided below the play surface 28 and counter section 92 between the first end support 24 and second end support 26. As illustrated, the divider 98 comprises a panel member spaced from the second end support 26, thus creating a generally enclosed space. Preferably, the trash bin 94 is located in this area. In one or more other embodiments, other elements or devices may be located in this area instead of the trash bin 94. For example, in one embodiment, a coin acceptance device, coin sorting device, and coin storage device (such as a coin hopper) may be located in the area. In this arrangement, the area may be enclosed with a door which is lockable.

As described above, the game station 20 preferably includes at least a first and a second display 34,36. In one embodiment, the first and/or second display 34,36 is capable of presenting “picture-on-picture” (i.e. present the information from two or more channels or sources at the same time in different areas of the display).

At least one game controller is adapted to control the displays 34,36 and present a game thereon for play by a player. FIG. 2 illustrates one embodiment of an arrangement of a game and entertainment system 100 for presenting a game and other information/entertainment to a player or user of the game station 20. In this embodiment of the invention, a first gaming controller 102 is provided for controlling the aspects of the game station 20 as necessary to present a first game. A second gaming controller 104 is provided for controlling the aspects of the game station 20 as necessary to present a second game.

In one embodiment, the first and second gaming controllers 102,104 include hardware and/or software for implementing one or more games. In another embodiment, some or all of the software (in the form of executable code or other data, such as video and audio data) may be stored remotely and be provided to each controller 102,104 as necessary. In one embodiment, a remote game controller may operate the game, and provide data, such as video and audio data, to the controllers 102,104 of the game station 20 for implementing the game. In that instance, very little or none of the game software is resident at the game station 20, lessening the risk of tampering.

In one embodiment, the first gaming controller 102 provides video data to a video memory 110, which data is converted to an analog signal and amplified by a video amplifier/converter 112. In one embodiment, the signal provided by the first gaming controller 102 comprises data for illustrating the elements of a first game on the first display 34. In one or more embodiments, a digital signal may be provided directly to the display 34.

In one or more embodiments, the first display 34 is capable of displaying content from one or more other or additional sources. In one embodiment, this is accomplished with a tuner or other video signal selector 114. A video control 115 may be provided on the console 30 or at any other location of the game station 20 for permitting a player to select the content of the information to be displayed by the first display 34. In one embodiment, the video control 115 may comprise one or more buttons, a rotatable selector, buttons illustrated on the display 34, or other input means known to those of skill in the art.

In one embodiment, a player may cause the first display 34 to display information from the first gaming controller 102, or from another source. In another embodiment, the first display 34 permits “picture-on-picture.” In a preferred embodiment, the first display 34 always displays information provided by the first gaming controller 102. In addition, however, the player may select other information to be displayed in a secondary area of the display.

In one embodiment, one or more video feeds or signals are provided to the tuner 114. A variety of video signals may be provided. Such video signals may include a video feed from a day care (on or off-site) or other location at which a camera obtains content input, or sports events, movies, television, or information channels provided by the operator. In this arrangement, the player may play a first game using the first display 34, and at the same time watch their children (via a day care video feed), watch a movie or television, or watch a sporting event. In one or more embodiments, the player may be permitted to access the Internet or a local intranet and have that information displayed by the first display. In one embodiment, “kiosk” type information may be displayed by one or both displays 34,36. Such information may comprise information regarding a hotel or casino at which the game station 20 is located, special events, restaurant information (such as menu information) show information, and reservation/ticket ordering information and the like. In one or more embodiments, a player may be permitted to interactively place reservations, order tickets and the like from the game station 20, such as by using a credit card, credits provided to the game station, or credits associated with an account usable with a player card readable by the game station.

In a preferred embodiment of the invention, the second gaming controller 104 is configured similar to the first, and provides a video signal to the second display 36. The video data preferably passes through a video memory 116 and amplifier/converter 118. In addition, a second tuner 120 is provided which permits a player to select the content of the information displayed by the second display 36. In such event, a controller or other input (not shown) may be provided to allow the player to select the particular content to be displayed by the second display 36.

In one or more embodiments of the invention, the first and second gaming controllers 102,104 are capable of presenting Class II and Class III games as defined by the Indian Gaming Regulatory Act (25 U.S.C. §2703, incorporated herein by reference). In a preferred embodiment, one of the controllers is adapted to present one or more Class HI or both Class HI and Class II type games, and the other controller is adapted to present one or more Class II (and no Class III) type games. Such games may comprise video slots, video poker, electronic bingo, keno and other games now known or later developed. Preferably, completely independent games are presented to a player by the two displays 34,36. By independent, it is meant that the games do not relate to one another (i.e. the entitlement to play each game is independent, such as based on independent wagers, and player input and the results of each game are independent). The games may be the same in nature, for example, the player may play two independent games of video poker. In a preferred embodiment, the games are different games.

As detailed herein, the game station 20 is adapted to present at least two games simultaneously or concurrently to a player. By the terms simultaneously and concurrently it is meant that during one or more times, two or more games may be presented and played. The games need not start and end at the same time, but at one or more times, two or more games are ongoing.

In a preferred embodiment, a master controller 101 is in communication with the first and second gaming controllers 102,104 for use in controlling the entire system 100. In a preferred embodiment, the various peripherals, such as the card reader 52, bill validator 50, receipt printer 60, light 64, and other peripheral devices as described above. In the embodiment where the seat 70 and other features are provided which are electronically controlled, such devices may be controlled by and through the master controller 101.

The game station 20 is uniquely configured and sized in a manner which causes a number of advantages to be realized. In one embodiment, the length of the game station 20 (i.e. from the first end support 24 to the second end support 26) is about 36 inches. The width of the game station 20 is about 36 inches. The distance from a supporting surface (such as a floor) to the bottom surface of the play surface 28 is preferably about 27 inches. The height of the play surface 28 is preferably about 30 inches. In this configuration, the play surface 28 is sufficiently low that a player sitting in the seat 70 may allow their feet to touch the ground. At the same time, there is sufficient distance below the play surface 28 to accommodate the player's legs thereunder.

In a preferred embodiment, the console 30 rises upwardly a sufficient distance to serve as a screen or barrier to players on either side of the game station 20 from seeing one another when seated. In one embodiment, the console 30 rises upwardly about 13 inches above the play surface 28 (i.e. to a total height of about 43 inches above the support surface, and about 24 inches above the height of the horizontal portion of the seat 70). The width of the game station 20 along with the height of the console 30 results in the player having a large amount of actual and perceived personal space, as described in more detail below.

As detailed above, the construction of the game station 20 and its specific configuration/shape may vary. Preferably, the game station 20 is constructed so that it is relatively narrow. As stated above, in one embodiment, the total width of the game station 20, including the seats 70, is only about 74 inches. In one embodiment, the total width of the game station 20 between opposing panels 40 is only about 8 inches. This narrow width is advantageous since it allows the seats 70 to be placed close to the game station 20 and still provide room for the player's legs.

Referring to FIG. 1, in one embodiment, a generally central vertical support 130 is provided within the interior space between the opposing panels 40. This central support 130 may extend between the first end support 24 and second end support 26. In a preferred embodiment, the gaming controllers 102,104 are mounted to and supported by the central support 130. In one embodiment, the gaming controllers 102,104 and other circuitry and components may be arranged vertically in a vertical plane paralleling the central vertical support 130. Alternatively, such may be located horizontally under the play surface 28.

In one embodiment, the interior space on one or both sides of the central vertical support 130 is further divided into at least two compartments: a first compartment in which the first gaming controller 102 is located, and a second compartment in which the second gaming controller 104 is located. Such an arrangement effectively secures the two game controllers 102,104 from one another, addressing requirements regarding maintaining the integrity of the games as may be required by law.

In one or more embodiments, the game station 20 includes a plurality of other features. For example, in one embodiment, a keypad 140 or other input device is provided. The keypad 140 may permit a player to input alpha-numeric information. This information may comprise a password, such as for use in activating the player's player tracking card/account.

In one embodiment, a cover 142 is provided for covering all or a portion of the play surface 28. In a preferred embodiment, the cover 142 comprises a transparent or substantially transparent member. As illustrated, the cover 142 comprises a generally planar sheet of plastic or similar material. In one embodiment, the cover 142 is relatively rigid a maintains a substantially planar configuration when raised or lowered.

As illustrated, the cover 142 is preferably hingedly mounted to the game station 20, thereby permitting it to be rotated from a raised to a lowered position. In the lowered position, the cover 142 extends over the play surface 28 adjacent thereto. In the raised position, the cover 142 is positioned above the play surface 28 and permits access thereto. For example, in the raised position, a player may place bingo cards, keno cards or similar items on the play surface 28. When lowered, these items are maintained in place and protected by the cover 142.

In an alternate embodiment, the cover 142 may be either fixed in position slightly above the play surface 28. In this arrangement, a slot or gap is provided between the cover 142 and play surface 28 which permits a player to place items there between. This allows a player to place bingo cards or similar items both between the cover 142 and play surface 28, and on the cover 142 in two layers or planes.

In one embodiment, the game station 20 includes one or more speakers or other sound-generating devices (not shown). One or both game controllers 102,104 may provide output to the sound generating devices for generating sounds associated with the games being presented. In addition, the tuners 114,120 may provide an output to the sound generating devices. In this manner, a player may hear the audio data associated with a movie, television or other video being presented on the displays 24,26.

In addition, in one embodiment, a jack 146 or other member is provided for providing an audio output. The jack 146 may be arranged to accept a plug or other input from a sound-generating device, such as a pair of headphones worn by a player. In one embodiment, an amplifier is provided which permits the player to adjust the sound level (such as with a level control).

In one or more embodiments, a player input is provided for configuring the game station 20 in a particular manner. In one embodiment, physical characteristics of the game station 20 may be changed to accommodate a particular player. These characteristics or features include, but are not limited to, the position (such as height) of the seat 70 and the sound level of audio. In one embodiment, a player may create a “profile” comprising data regarding these characteristics. The data file may be created when a player creates a player account, such as when obtaining a player tracking card. Alternatively, the player may create the account at the game station 20, such as by interfacing with a system via the first and/or second displays 34,36 and using the keypad 140 or other input. In another embodiment, a disabled or impaired player may provide game accessibility configuration data, game input data or similar information through an input jack/data port.

In one embodiment, an instruction is provided which causes the game station 20 to configure itself based on the player's desired characteristics. As stated above, in one embodiment, the game station 20 includes a master controller 101 which controls the entire operation of the game station 20, including the first and second gaming controllers 102,104. In one embodiment, the master gaming controller is adapted to provide command signals to one or more of the peripheral devices or features of the game station 20, such as a motor drive for the seat 70, or an amplifier for the audio system. In one embodiment, a player provides an input which provides the player profile data to be provided to the master gaming controller. The master controller 101 then uses this data to configure the game station 20. In one embodiment, the master controller 101 is arranged to accept credit input signals (such as from a coin acceptor, bill validator or coupon reader). The master controller 101 is also arranged to provide control signals to the first and second gaming controllers 102,104 for causing them to initiate a game (such as by providing a signal indicating that a player has provide the appropriate credits for playing the game).

In one embodiment, the player may identify themselves with their player tracking card. In another embodiment, a player may input a particular account number or other identifier with the keypad 140 or other input device.

In one or more embodiments, the player profile information is stored at a remote location, such as a memory storage device of a remote server. In that instance, the player profile information is sent from the remote location to the master controller 101. In another embodiment, the player profile information may be stored locally. Alternatively, the player profile information may be stored on the player card, such as encoded and stored on a magnetic stripe of the card.

In another embodiment of the invention, the game station 20 may include a data interface, such as a data port (not shown). The data port may be arranged to accept a RJ-11 jack, RS-232, USB or other cabled device. The data port may also comprise an infrared or radio-frequency wireless port. In any event, the data port is arranged to accept data from an external device. The external device may comprise a computer or other device.

In a preferred embodiment, a player may provide input through the data port. This input may comprise identification data for use in the master controller 101 obtaining player profile data. The input may also comprise substantial game play input information, such as bet data and particular game play input.

In one embodiment of the invention, the game station 20 includes at least one microphone or other device for accepting audible input. In a preferred embodiment of the invention, the audible input is provided to the master controller 101 and/or other control devices of the game station 20 for use in playing a game presented thereon or otherwise providing input to the game station 20. In one embodiment, the master controller 101 may be provided with a “learning mode” for learning the voice of the player, as is known in the art of voice-controlled word processing and the like. In this arrangement, the master controller 101 may request that the player repeat one or more words, such as key control words, for learning the player's voice.

The game station 20 may be adapted to permit audible input to control a variety of aspects of the game. In one embodiment, the audible input may be used to select and play a game. The audible input may be used to control various settings of the game station 20, such as what is displayed by the displays 34,36. For example, an audible input such as “start game,” “bet one credit,” “spin,” and “cash out” may be used as control commands. Of course, those of skill in the art will appreciate that the commands may vary as necessary.

In one or more embodiments, one or more electro-mechanical or mechanical inputs may be provided for permitting a player to provide input to play the game(s) presented instead of providing such inputs through the displays 34,36. In one embodiment, a plurality of touch or push buttons may be provided for such a purpose. These buttons may permit a wide variety of functions, such as allowing the player to bet credits, make game decision selections, cash out or the like, as is well known to those of skill in the art.

In another embodiment, other game station configurators or configuring device/means may be used other than a master controller for the purpose of configuring the game station 20 in accordance with a player's profile/instructions.

In one or more embodiments, other features may be provided for addressing particular needs of a player. For example, in one embodiment, the receipt printer may comprises a braille printing device for printing information such as instructions and game information to a player with a visual impairment. Such a player may provide input through a remote device, or through input devices such as buttons having braille printing thereon.

In another embodiment, the game station 20 may be (or also be) particularly adapted to an auditorily impaired player. As stated above, a jack 146 may be provided for providing an audio feed to a player's personal sound-generating device, such as headphones, which may allow the player to increase the volume of the audio without disturbing others. In another embodiment, information which is normally provided in audible form may be provided in an alternate manner, such as visually. For example, a game may be arranged so that when the player is a winner, an audible “winner” is sounded. In an alternate embodiment, such an indication may be provided visually by the displays 34,36 or by lights or other indicators. In these embodiments, a player having special requirements may provide an input to the game station 20 causing the controller 101 to configure the functions thereof to meet the needs of the player. In one embodiment, such input may be provided by a player through a menu displayed by one or both displays 34,36. In an other embodiment, the input may be provided through the interface (such as a data port). For example, as stated above, a player identification number may be provided which is associated with particular game station 20 configuration data, thereby causing the game station 20 to configure itself to suit the particular needs of a player.

In one embodiment of the invention, one or more communication links may be provided between one or more of the game stations 20 or other devices for a variety of purposes. As described below, the master gaming controller 101 of one or more of the game stations 20 may be linked to a common remote location at which is stored personal profile data and even game data. In another embodiment, the game stations 20 may be linked to provide jackpot and other features. For example, in one or more games provided for play, a plurality of the stations may be linked and a portion of bets received to play at least one or more games aggregated for forming a jackpot. This jackpot amount may then be posted and provided to win by playing any of the linked game stations 20. In these arrangements, wired or wireless data links may be provided for transmitting information.

In one embodiment, information may be displayed by the first and second displays 34,36 or other display devices. For example, in one embodiment, a set top display 150 may be provided. The set top display 150 may include a display device, such as a plurality of LED's or an LCD or other device for displaying information visually. The set top display 150 may be positioned on top of the console 30. The set top display 150 may be controlled by the master controller 101 or other control device for displaying a wide variety of information. Such information may include jackpot information, game play information, hotel/casino information or the like.

One or more aspects of the invention comprise a method of placing a wager. As detailed above, the game station 20 includes at least one means for a player to place a wager. This means may comprise a bill validator or coupon reader, a coin acceptor and/or a card reader. Using the bill validator, a player may utilize bill monies to provide value or credit to the game machine 20. Using a coupon reader, the player may provide a coupon or ticket having value. Using the coin acceptor, the player may deposit coins, and using the card reader, the player may associate value with the game machine which were either associated with the card or with a central data file.

In one embodiment, a player may provide credit or value at a location remote from the game station 20, but then have that credit associated with the game station for establishing entitlement to play a game or play for goods or services. For example, a player may provide cash to a cashier at a location remote from the game station. That cashier may issue the player a coded player card, smart card, or other device which, when presented to the game station either establishes an association with the player and an account or which based on the data on the card otherwise confirms that the credit has been provided.

In accordance with a preferred embodiment of the invention, the player may associate the provided credit or value with any of a variety of functions/devices. As detailed above, in one embodiment a player is required to place a bet in order to play a game presented on either the first or second display. In accordance with the invention, the player may associate provided value with either the first game or the second game, or both, so as to be entitled to play these games. In one embodiment, the player may distribute the provided value as desired between the games.

As another aspect of the invention, the player may utilize the provided credit for payment of goods or services. For example, a player may wish to order food or drinks, place a show or hotel room reservation or the like using the kiosk feature of the game station 20. In such event, the player may utilize the credit or value for this purpose.

This aspect of the invention may be implemented in a variety of manners. In one embodiment, the player establishes an account, and provided value is associated with the account. Information regarding the account may be displayed on one or both of the first and second displays. A menu may be provided which permits the player to manage the account. The menu may include items such as “allocate funds to first game,” “allocate funds to second game,” and the like. Of course, the allocation may be equal or unequal. For example, a player may wish to play only one game more than another game which is presented, and thus will allocate more funds or credits to one game than the other.

A variety of means may be provided for allocating the funds. In one embodiment, the device comprises the master gaming controller. As stated above, input may be provided by the player to the master gaming controller using a variety of input devices, such as a touch screen. The master gaming controller has a memory for storing credit or funds data, and is configured (such as by running software code or by hardware) to display the menu to the player, to increase and decrease funds amounts and the like. In one embodiment, when a player allocates funds to a particular game, the master gaming controller is adapted to provide a signal to the game controller which presents that game, establishing that the game may be played by the player. Of course, in another embodiment, the credit/funds data and such processing may be accomplished remote from the game station.

The accessible value or credit may rise and fall depending on the activities of the player and the outcome of games. If a player wins a game, the amount won may be associated with the accessible credit. In one embodiment, when a player wins one game, the player may use those accessible funds for playing any other presented game. If a player places a number of losing wagers or orders food or drink, the players accessible funds may be reduced or exhausted.

As stated above, in one embodiment, the credit or value is associated with a data file which is stored at the game station 20 or a remote location, such as a server. In one embodiment, value is associated with a player as identified by information associated with the player's tracking card. In such event, the player must utilized his or her card to identify him or herself in order to begin using the game station 20, and then log off or quit to ensure the association of the credits at that time with the player's account. In another embodiment, the information is stored locally per session, and the player must provide credits and when finished playing, cash out. The player may cash out in a variety of manners, such as by being paid coins, provided with a coupon representing the cash out value, or by storing the data at an electronic account for later access by the player.

In one or more embodiments of the invention, in the event a player pays for goods or services through the game station 20, the player is only returned “change” in the form of credits or a voucher usable for playing games on the game station 20. For example, a player may input a $20 bill to the game station 20 and then play several games and order food. Instead of being permitted to obtain the difference of the amount credited and that due for playing the games and paying for the food in the form of coins or cash, the player may be provided only with a voucher which can be read by another gaming machine.

In one or more embodiments of the invention, the game station 20 need not comprise a single unit having the two displays for presenting two independent games. For example, the game station 20 may comprise two stand-alone or otherwise individual/separate units which are associated with one another. Of course, the separate units are preferably located close to one another and configured to achieve the benefits described herein. Further, in this embodiment of the invention, at least one common means is provided for permitting a player to provide credits to both of the units providing the games. In one embodiment, the separate units may each have a display and game controller. The separate units may be physically connected or be placed proximally to one another. In order to accommodate the function of the player placing a wager, one or both of the units may have a card reader, bill validator/coupon acceptor or the like. In the event just one of the separate units has the credit accepting/verifying device, then the second unit may be linked to the first with a wireless or wired data connection permitting transfer of credit information and the like. In another embodiment, the two units may be connected through a common hub or server.

As used herein, by the term common it is meant that by a player providing credit through a single device or in a single manner, provided credit can be used to play the independent games. The credit accepting device, such as a coupon reader, may not be physically linked with both games, but the accepted credit may be used to play both games. As described above, such may be accomplished through a single master controller, through a data communications link between separate gaming controllers or in other manners.

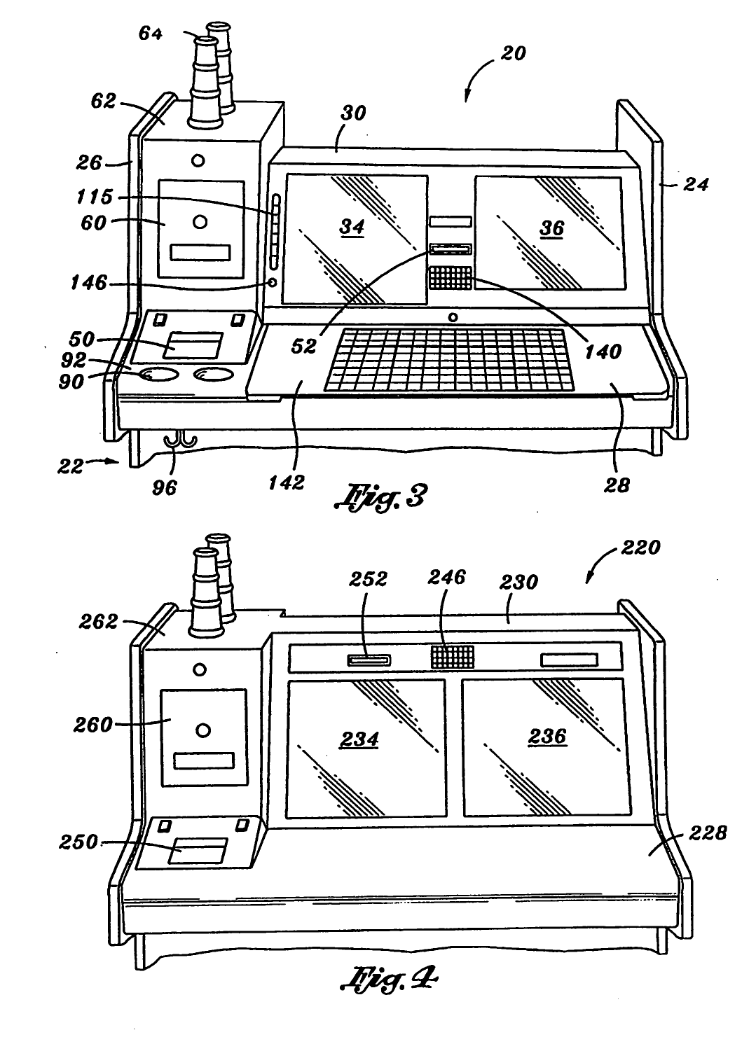

Another embodiment of a game station 220 is partially illustrated in FIG. 4. This embodiment game station 220 is similar to the last, and includes a base portion 222, first and second ends 224,226, a console 230 and first and second displays 234,236 associated with the console 230. In this embodiment, the displays 234,236 are located directly adjacent to one another and the console 230 is slightly taller, allowing the displays 234,236 to be larger. A keypad 246 and card reader 252 are preferably located above the first and second displays 234,236, thereby permitting the displays 234,236 to have a larger width dimension.

In this embodiment, a printer 260 and bill validator 250 are again associated with a housing 262. To further reduce the depth of the game station 220, however, the play surface 228 does not extend as far outwardly from the console 230. Cup holders are eliminated in favor of additional play surface for the player.

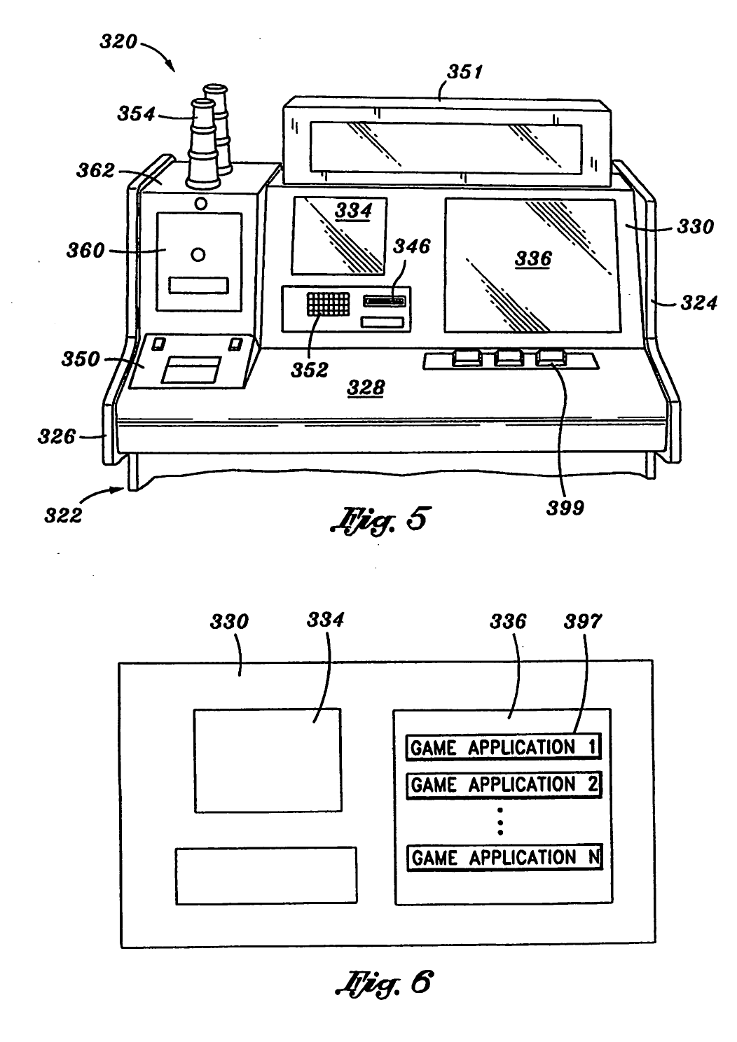

A game station 320 in accordance with yet another embodiment of the invention is illustrated in FIG. 5. This embodiment game station 320 is primarily directed to a station permitting players to participate in multiple electronic games (or one or more games and view video or other electronically presented information), but does not include a play surface which is particularly adapted to permit play of games thereon, such as paper bingo or keno.

As illustrated, the game station 320 is similar to that illustrated in FIG. 1, and includes a base unit 322, first and second ends 324,326, a play surface 328, a set top display 351, a console 330, and a housing 362. Once again, a variety of elements or devices may be associated with the housing 362, such as a printer 360, a bill validator/ticket or coupon reader 350, and one or more lights 354. In the embodiment illustrated, one display 336 is a large display primarily adapted to present games, such as video slot and video poker games. In this embodiment, one or more electro-mechanical buttons 399 or other input devices (other than touch-screen input to the display) are provided. The buttons 399 are conveniently provided on the play surface 328.

The other display 334 is primarily adapted to present other than games, such as movies, information, television programming and the like. A card reader 352, keypad 346 and other controls are preferably located adjacent the smaller display 334.

In this embodiment, the play surface 328 is again smaller than the play surface 28 of the game station 20 illustrated in FIG. 1. As stated above, in this embodiment, the play surface 28 need not be as large because the game station 320 is not arranged to be used by a player to play other than the games primarily presented on the displays 334,336. This allows use of a larger display using the same game station footprint/size. In this embodiment, the small play surface 328 still provides substantial functionality to a player. The play surface 328 allows a player to store personal items or engage in other activities. In addition, the play surface 328 still contributes to a player's sense of substantial personal space.

Referring to FIG. 6, an illustration is provided of a menu which may be displayed by the primary game display 334 of the game station 320. As illustrated, a plurality of menu items 397 are displayed, each associated with a particular game which may be selected by a player for play. As described above, the selection may be permitted through direct input to the display 334, or by other means, such as buttons or the like.

In one or more embodiments of the invention, it is contemplated that one or more games may be presented by other than a video display. For example, in one embodiment, the console of the game station may house a electro-mechanical slot type device and a display. It is also contemplated that a video display or other game device may be located in or on the play surface. For example, a thin LCD panel may be mounted in the play surface.

In one or more embodiments, the game station of the invention need not include two player areas located back-to-back. For example, in some instances a gaming operator may wish to locate the game station against a wall. In such event, the game station may be provided with a single play area and have a generally flat, enclosed back for placement against a wall. Such an arrangement is also suitable to use in a bingo or keno parlor, sportsbook or other environment where it is desirable for all players to face generally one direction.

In one or more embodiments, the gaming controllers are adapted to provide random outputs. The operation of such controllers is known.

In one or more embodiments, the displays and other devices need not be associated with a unified console or housing. For example, the displays may be of the stand-alone type and simply rest upon the play surface or otherwise be supported by the base unit. In one embodiment, a separate console and housing is not provided, but instead, a single console is utilized. The embodiment illustrated in FIG. 1 is particularly advantageous because the displays and other devices (printer/validator) are independently accessible and thus also independently securable.

In one or more embodiments, the playing surface is adapted to accept game peripheralia and other items, such as personal player items. The game peripheralia may comprise bingo cards, keno cards, daubers, odds sheets, race sheets, parlay cards, markers and pencils.

It is contemplated that a variety of input device may be provided for permitting a player to interface with the game station. These devices include touch screens, buttons and keypads as described above. In addition, the means of input may comprise a track ball, joy stick, mouse or other pointing device, keyboard. As described above, the means of input may be externally controlled, such as comprise a physically disabled player's wheelchair mounted joystick or other environmental control device.

A variety of other player comfort features are contemplated. Though not shown, the game station may include an oxygen source for providing oxygen to players who require such. An air filtration system may be provided at the station for cleansing the air near the station.

A variety of benefits and advantages are realized by the present invention. First, a game station 20 is provided which is capable of simultaneously or concurrently presenting to a player at least two different games on one or more displays. In one embodiment, these games may be of different types, such as Class II and Class III games. As a further aspect of the game station 20, a player is permitted to play bingo, keno or a variety of other games on the play surface 28. It will be appreciated that in one embodiment, a player may play electronic bingo as presented via one of the displays and/or “paper” bingo (i.e. where cards are daubed) on the play surface.

A particular advantage is realized by presenting to a player both Class II and Class III type games. These types of games are particularly suited to being played by a player at the same time, such that the player is highly entertained, and the gaming operator has the opportunity of obtaining greater wagers (or at least a greater value of wagers in a given time) from the player than if the player only played a single game. For example, while waiting for numbers to be called while playing bingo or keno, the player may play games of video poker or video slots.

In one or more embodiments, a player may play a game presented on one display and watch video on the other (such as television, a movie or the like). A player may also play two games simultaneously or concurrently as presented on the two monitors, and also watch video, such as presented in a picture-on-picture on one or both displays.

A player may either separately, or in addition to participating in one or more games presented on the displays, play one or more games on the play surface. For example, a player may play one or more games of bingo, and/or one or more games of keno or other the like on the play surface.

When considering the embodiment of the game station 20 having two player areas, the game station 20 is capable of simultaneously presenting at least 4 games associated with the displays, and permits the players at the two player areas to participate in a plurality of additional games on the play surfaces. Thus, the game station 20 is capable of permitting play of as many as 8 or more games at the same time within the space occupied thereby.

The arrangement of the game station 20 is advantageous in that multiple games and events are presented to a player in a compact space. Because of the configuration of the game station 20, a casino or other gaming operator may operate a large number of the game stations 20 in a given square footage of space. As described above, it is desirable for gaming machines to have a small footprint, thus allowing a greater number of the machines per unit area, as this generally increases the ability of the gaming operator to make profits. Commonly, upright slot or video machines which present one game at a time to a single player have a footprint of about 24″ by 28″. When two such devices are placed back-to-back to present a game to each of two players, the total footprint is 48″ by 28″, or about 9.3 square feet. The game station of the present invention occupies less space, about 36″ by 36″ (or 9 square feet), and yet permits at least two players to play games, and presents to those players multiple games simultaneously or concurrently.

In one or more embodiments, several of the game stations 20 may be “daisy-chained” together, reducing the amount of space a plurality of the game stations 20 occupies and reducing the complexity of providing electricity/electronic connections.

As stated above, one or more of the game stations 20 may be associated with a central or common server. In such event, a common controller (including a common random number generator) may generate game data. This data may be provided to each game station 20. In this arrangement, individual gaming controllers are not needed at each game station 20, but instead one or more centralized controllers may be utilized.

Another advantage of the game station 20 is that it can be used in place of tables or similar equipment located in sportsbooks and bingo/keno parlors. When used in replacement of these tables, however, the game station 20 presents the opportunity for players to engage in additional activities, and presents the opportunity for the casino operator to increase the revenue associated with that particular floor space

In the preferred embodiment of the invention, while the game station 20 is wider than some stand-alone slot and other types of game machines, the game station 20 has two player stations presented back-to-back. Because of the arrangement of the game station 20, the depth of the single game station 20 is minimized as compared to placing stand alone machines back-to-back. In addition, the revenue which the game station 20 is capable of generating is greater (in relationship to the space occupied by the station 20 as compared to a standard slot or similar machine) than that of a standard slot or similar gaming machine. This is because the length of time which a player wishes to play and the amount wagered during that time is increased as a result of the multiple games presented to the player at the same time and the other entertainment features of the game station 20.

Another benefit of the game station 20 is that it is player-friendly. As is well known, each human generally requires a certain amount of space to be comfortable. In the case of standard gaming machines which are arranged side-by-side, this space is not provided. The players of gaming machines arranged in the standard fashion are too close to one another to satisfy the personal space requirements. This often leads to players not feeling comfortable enough to play the gaming machine for a long period of time.

In the case of the gaming machine 20 of the present invention, this personal space need is satisfied. First, the gaming machine 20 is wider than normal gaming machines. If placed side-by-side, each player has enough space to feel comfortable. The generally flat and large play surface 28 also lends to a sense of larger personal space.

While the gaming station 20 is not very deep and players on either side of the gaming machine 20 are in true distance very close, the players do not perceive such because of the dividing console 30.

The game station 20 has a variety of features which cater to a player's comfort and desire to remain at the game station 20 and play games. These features include the cup holders 90, the tray 80, seat 70, foot rest 74, coat hook 96 and others. These features all contribute to a player's sense that, once stationed at the game station 20, the game station 20 is the player's own personal area. The seated position at normal seating height also contributes to the comfort of the player.

The game station 20 is also user-friendly to a wide variety of different players, including those with disabilities or impairments. As stated above, the game station 20 is arranged in a table-type format, and has a raised unit. This permits wheelchair access and use by player's who would otherwise have difficulty in sitting in a substantially raised chair or stool. In one or more embodiments, the seat 70 may be moveable to permit access to the game station by a player not needing the seat. For example, a wheelchair bound player may move the seat 70 and remain seated in their wheelchair while utilizing the game station. As is noted above, the configuration of the game station is unique in this regard that it does not have a particular configuration which makes it useable in only one manner (such as by sitting upon a stool of a particular height), but is accessible to a wide range of the public. It is also noted that the configuration of the game station 20 is particularly suited to a wheelchair bound player as it permits the player to position their wheelchair partially under the play surface and thereby sit close to the controls and displays. Further, the displays are at eye level with such a player. The particular configuration of the game station 20 is such that the height of the play surface meets federal standards for access by disabled persons.

In one or more embodiments, persons having physical motor impairments (e.g. cerebral palsy) can communicate with the game station 20 using other input functions, such as by input through a personal communication device. Instructions, as in the form of electronic signals, may be sent from a physically disabled or impaired player's computer or other device to the master controller 101 or other device. For example, a physically impaired player may not be able to make selections on the displays 34,36, but may have a joystick or mouse associated with a personal computer, and use that joystick or mouse control to make selections.

In another embodiment, a player may use audible commands to interface with the game station 20.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. A single game station configured to present multiple independent games simultaneously to each of two players using the game station comprising:
a base unit having an upwardly extending base portion;
a first end and a second end and a first side and a second side, said game station between said first and second ends thereof defining a first single player station at said first side thereof and a second single player station at said second side thereof;
a housing extending upwardly from said base portion at said second end of said game station, said housing having a first side and a second side corresponding to said first and second sides of said game station;
a console extending upwardly from said base portion between said first end of said game station and said housing, said console having a first face facing outwardly at said first side of said game station and a second face facing outwardly at said second side of said game station;
said first single player station comprising:
a first horizontal playing surface extending outwardly from said first side of said game station below said console, said first playing surface sufficiently large to accommodate at least one physical game card, permitting a first player to play at least one game using said game card at said game station;
a first and a second electronically controlled video display at said first face of said console, said first and second video displays located above said first playing surface;
at least one first game controller adapted to present information regarding at least one first game on said first video display and at least one second game controller adapted to present information regarding at least one second game on said second video display, said first and second games independent of one another and capable of being played at the same or different times; and
at least one first wager accepting device located in said housing and accessible at said first side of said housing, said at least one first wagering accepting device adapted to accept a wager placed by said first player of said game station to play either or both said at least one first game and said at least one second game;
said second single player station comprising:
a second horizontal playing surface extending outwardly from said second side of said game station below said console, said second playing surface sufficiently large to accommodate at least one physical game card, permitting a second player to play at least one game using said game card at said game station;
a third and a fourth electronically controlled video display at said second face of said console, said third and fourth video displays located above said second playing surface;
at least one third game controller adapted to present information regarding a third game on said third video display at least one fourth game controller adapted to present information regarding at least one fourth game on said fourth video display, said third and fourth games independent of one another and capable of being played at the same or different times;
at least one second wager accepting device located in said housing and accessible at said second side of said housing, said at least one second wager accepting device adapted to accept a wager placed by said second player of said game station to play either or both said at least one third game and said at least one fourth game;
whereby said game station defines first and second player stations at opposing sides thereof with the console and housing at each of said player stations arranged in inverse relationship and such that a single first player may concurrently play at least one game using a game card on said first playing surface and said first and second games as presented on said first and second displays and such that a single second player may concurrently play at least one game using a game card on said second playing surface and said third and fourth games as presented on said third and fourth displays.

2. The game station in accordance with claim 1 wherein said first and second playing surfaces are at least about 14 inches deep to accommodate three bingo cards in depth.

3. The game station in accordance with claim 1 including at least a first tuner adapted to accept a video feed and at least one selector for use by said first player in controlling said first tuner to present video information on said first or second video display and at least a second tuner adapted to accept a video feed and at least one selector for use by said second player in controlling said second tuner to present video information on said third or fourth video display.

4. The game station in accordance with claim 1 wherein said first and second playing surfaces extend outwardly from said upwardly extending base portion by at least about 12 inches to accommodate the legs of the first and second players thereunder.

5. The game station in accordance with claim 1 wherein said upwardly extending base portion defines a first vertical surface located under said first playing surface and an opposing second vertical surface located under said second playing surface and said at least one first and second game controllers are mounted to said first vertical surface and said at least one third and fourth game controllers are mounted to said second vertical surface.

6. The game station in accordance with claim 1 including a first keypad mounted to said first face of said console between said first and second displays and a second keypad mounted to said second face of said console between said third and fourth displays.

7. The game station in accordance with claim 1 including a first generally transparent cover, said first cover movable between a first raised position in which said first playing surface may be accessed and a second lowered position in which said first cover extends over said first playing surface and a second generally transparent cover, said second cover movable between a first raised position in which said second playing surface may be accessed and a second lowered position in which said second cover extends over said second playing surface.

8. The game station in accordance with claim 1 wherein said first and second video displays are arranged in side by side configuration at said first face of said console and third and fourth video displays are arranged in side by side configuration at said second face of said console.

9. The game station in accordance with claim 1 wherein said first and second playing surfaces extend outwardly from said base portion about 30 inches above a bottom of said base portion, whereby said first and second playing surfaces are positioned for use by seated players having their legs extending thereunder.
